(19) United States
(12) Patent Application Publication
(10) Pub. No.: US 2010/0032450 A1
(43) Pub. Date: Feb. 11, 2010

(54) ULTRASOUND GEL DISPENSATION

(76) Inventors: Patrick AHLUND, Taby (SE); Mikael LINDGREN, Upplands Vasby (SE)

Correspondence Address: OSTROLENK FABER GERB & SOFFEN, 1180 AVENUE OF THE AMERICAS, NEW YORK, NY, 100368403, US

(21) Appl. No.: 12/188,461

(22) Filed: Aug. 8, 2008

(51) Int. Cl. B65D 35/56; B67D 3/00

(52) U.S. Cl. 222/105; 222/527

(57) ABSTRACT

A gel dispensing device comprises a flexible container filled with ultrasound contact gel, a dispensing tube having a dispensing end and a mounting end, and a device for mounting the mounting end of the tube on the container. Also disclosed is a corresponding ultrasound gel dispensing tube, a dispensing assembly comprising the tube and an adapter.

### FIELD OF THE INVENTION

The present invention relates to a device for dispensing ultrasound gel to the lumen of an ultrasound probe cover and to a use of the device.

### BACKGROUND OF THE INVENTION

Ultrasound probe heads are not easily sterilized. To protect the patient during an ultrasound scan or an ultrasound guided biopsy procedure, the ultrasound probe head is covered by an ultrasound probe cover or sheath of a thin and flexible polymer material. Air is a bad conductor of ultrasound waves. To ensure the proper transport of ultrasound waves through the cover the formation of air pockets in the cover has to be avoided. For this reason an aqueous contact gel is manually dispensed into the cover prior to use or a cover filled with gel during manufacture is used.

A drawback of dispensing gel by hand is that the operator must pay attention to maintain the sterility of the probe cover if so required. Another drawback is the difficulty to reach the desired site in the probe cover for dispensing the gel due to a narrow cover lumen or due to the site of dispensing being at a considerable distance from the opening of a long probe cover. For all kinds of narrow probe covers, in particular intra-cavity or endo-cavity probe covers, dispensing of gel to a desired site in the cover is difficult.

Also, the probe cover may be provided by the manufacturer in a folded configuration. Prior to dispensing gel into such a cover, the cover has to be unfolded and rolled up. This requires the person dispensing the gel to be assisted by another person doing the unfolding and rolling up work. After the gel is dispensed, the ultrasound probe head is inserted into the rolled up cover. Then the cover is unrolled along the probe head. A probe cover provided by the manufacturer in a rolled up configuration can be filled directly with gel. But gel cover similarly requires it be unrolled along the probe head after insertion of the head into the rolled up cover. Intra-operative probe covers, which may be up to 2.5 m long, are often folded in a donut shape. Certain probe covers cannot be rolled at all due to their size. For them, the only option is to provide them in a state filled with gel.

A problem with probe covers ready filled with gel is that the amount of gel may not be optimal for the particular probe head with which the cover is used. In particular, even if a sufficient total amount of gel is disposed in the cover, a portion of the gel may become disposed at a site where it is of no use, while the amount of gel available at a correct site where gel is needed is insufficient. Another drawback is the limited shelf life of prefilled covers, that is, with respect to the shelf life of a non-prefilled cover. A further drawback of ready filled probe covers is that they are not easily packed. Further, they may leak during storage or transport. A still further drawback of prefilled probe covers is the risk of mold growth in the gel. Also, the gel in the probe cover may lose water by evaporation and become more viscous during storage. The changed fluid properties of the gel may it render less suitable for the intended purpose. Probe covers prefilled with gel do not allow medical personnel to choose between gels available on the market, which may differ in their properties and suitability in respect of different applications, nor permit use of the amount of gel that they think is proper in a given situation. Therefore, the use of empty probe covers that are filled prior to use is still the rule.

Filling of probe covers is accomplished by manually dispensing a desired amount of gel from a mouthpiece of a flexible tubiform polymer container into a cover that is held upright with its open end uppermost. Due to the sticky nature of the contact gel, the flexible and physically unstable nature of the cover, the proper holding of the cover requiring close attention, facilities not particularly suited for the purpose in regard to lighting and space, and the possible short availability of medical personnel, a better way of filling an empty ultrasound probe cover with gel contact gel constitute a problem that is more than just a nuisance. The present invention seeks to solve or at least alleviate this problem.

### SUMMARY OF THE INVENTION

According to the present invention, a gel dispensing device comprises a flexible container filled with ultrasound contact gel, a dispensing tube having a proximal dispensing end and a distal mounting end, and a means for mounting the tube on the container. It is preferable for the dispensing tube to be closable at the dispensing end.

A closing means of the tube is arranged at the dispensing end preferably comprises one of: threads for mounting a threaded lock, a snap device for mounting a snap-on lock, and a friction device, particularly a roughened tube surface portion, for mounting a lock hold by friction.

According to a preferred aspect of the invention, the means for mounting the dispensing tube on the container comprises one of: inner threads, a snap-on connector and a friction connector. Preferably, the dispensing tube is from 15 cm to 50 cm long and has a lumen that, at its most narrow point, is from 12 mm² to 300 mm², preferably from 30 mm² to 130 mm².

According to another preferred aspect of the invention the mounting means and the dispensing tube and, optionally, the container are integral.

According to a third preferred aspect of the invention the ultrasound gel container comprises, at its closed distal end, a suspending device for suspending the container in a vertical position. A suspending device is selected from eye, sling, hook is preferred. The container can be suspended on, for instance, a stand of a kind used in a hospital for suspending infusion bags or bottles. Alternatively, the container can be suspended, for instance, on a hook mounted at the ceiling via a thin rope or similar. In its suspended position, the ultrasound gel container is easy to handle, allowing a single operator to dispense a desired amount of ultrasound gel into an ultrasound probe cover at or near the proximal end thereof An advantageous suspension height of the device of the invention is one at which the proximal end of the dispensing tube is disposed at a distance of 80 cm to 150 cm from the ground or floor.

According to a further preferred aspect of the invention the means for mounting the tube is in one piece with the tube or with a separate adaptor.

An ultrasound gel dispensing tube hereof is of a length from 15 cm to 50 cm and has a lumen that, at its most narrow point, is from 12 mm² to 300 mm², preferably from 30 mm² to 130 mm². The tube has a dispensing end and a mounting end and is mountable at its mounting end on a container filled with ultrasound contact gel. It is preferred for the dispensing tube to comprise one of: a thread mount, a snap-on mount, and a friction mount. The mounting means is disposed at the mounting end. It is furthermore preferred for the dispensing tube to comprise a releaseable closure at its dispensing end. The releaseable closure is preferably selected from: a threaded closure, a snap-on closure, a frictional closure, and a stopper.

According to a further aspect of the invention, an ultrasound gel dispensing assembly comprises the aforementioned dispensing tube and a mounting adapter. It is preferred for the mounting adapter to comprise a lumen interposable between the lumen of the dispensing tube and the lumen of the ultrasound gel container so as to provide communication between the dispensing tube and the ultrasound container.

The dispensing tube of the invention or the dispensing assembly of the invention are operable for dispensing ultrasound gel into an ultrasound probe head cover.

The flexible container filled with ultrasound contact gel can be one that is available on the market or one that is specifically manufactured for the purpose. Contact gel containers available on the market have mouthpieces that can be opened and closed, for instance by a screw cap, in which case the mouthpiece comprises corresponding external threads, or by a lock of a resilient material that can be fastened on and removed from the mouthpiece. Instead of using a contact gel container from the market, one may manufacture and use a container filled with contact gel specifically for the purpose of the invention. The mounting means of the device of the invention intended for use with a contact gel container of this kind can comprise an adapter with a bore comprising inner threads corresponding to the external threads of the mouthpiece or an adapter of a resilient material that can be fastened on the mouthpiece in the same manner as the lock of resilient material, respectively. The adapter of the invention has an inner bore extending from its proximal end to its distal end. The distal end of the adapter is the end proximal to the gel container.

The dispensing tube is preferably straight. It may be essentially stiff or only somewhat flexible. Alternatively the dispensing tube may be flexible. The lumen of the dispensing tube may vary over the length of the tube. For instance, the tube may comprise a portion having a wavy wall in an axial section.

According to a preferred aspect of the invention the adapter and the dispensing tube are integral.

According to a further preferred aspect of the invention the contact gel container comprises, at its closed end, a suspending device operable for suspending the container in a vertical orientation with its dispensing end down. The disposition means comprises preferably a suspension element, such as an eye, a sling or a hook. A suitable suspension height is one in which the proximal end of the dispensing tube is disposed at a distance of 80 cm to 150 cm from the floor.

According to still another preferred aspect of the invention a check valve is arranged in the tube, or the adapter or at the proximal opening of the container to prevent gel from escaping from container unintentionally, in particular with the container disposed vertically, and/or from being sucked back into the container.

It is preferred for the device of the invention to be made of polymer material.

### BRIEF DESCRIPTION OF THE DRAWINGS

The invention will now be explained by reference to a number of preferred embodiments illustrated in a rough drawing.

FIG. 1 shows a first embodiment of the gel dispensing device of the invention releaseably mounted on a state-of-the art ultrasound contact gel container, in a sectional view;

FIG. 1a is an enlargement of a fragment of FIG. 1;

FIG. 2 shows a second embodiment of the gel dispensing device of the invention integrated in an ultrasound contact gel container, in a sectional view;

FIG. 3 shows a third embodiment of the gel dispensing device of the invention releaseably mounted on an ultrasound contact gel container according to the invention, in a sectional view;

FIG. 3a is an enlargement of the connection between the container and the tube of the device;

FIG. 3b is an enlargement of the dispensing end of the tube;

FIG. 4 illustrates the dispensation of ultrasound contact gel into an ultrasound probe cover by means of the gel dispensing device of FIG. 3, in a perspective view.

### DESCRIPTION OF PREFERRED EMBODIMENTS

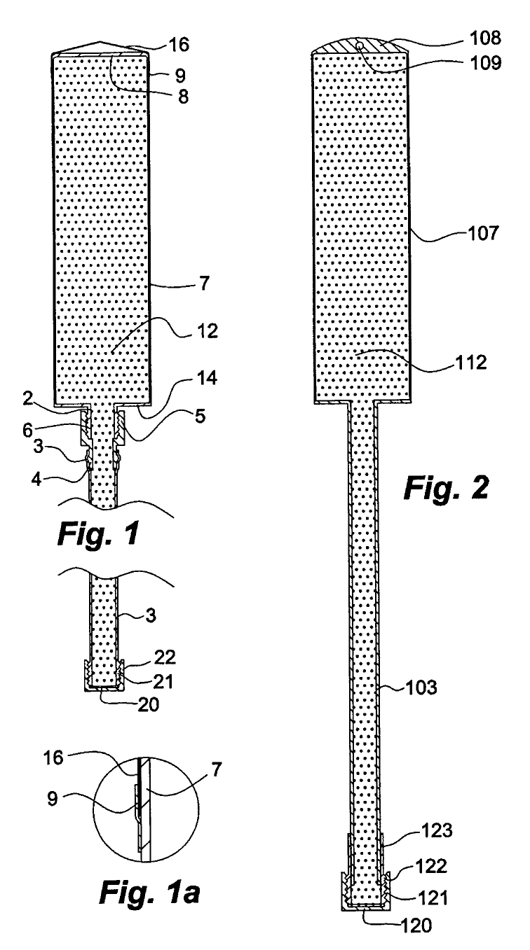

A first preferred embodiment of the gel dispensing device of the invention is illustrated in FIG. 1. A cylindrical state-of-the art ultrasound gel container comprises a cylindrical side wall 7 closed at its top or distal end by a circular top wall 8 and at its bottom or proximal end by a circular bottom wall 14. In contrast to the thin and flexible side wall 7 the top and bottom walls 8, 14 are relatively rigid. From the center of the bottom wall 14 extends a short cylindrical mouthpiece 2 with a lumen that is in communication with the inner space of the container. The outside of the mouthpiece 2 has threads 6 which receive inner threads 5 of a rotationally symmetric tube mounting piece 4 comprising an inner bore of about same diameter as the lumen of the mouthpiece 2. Proximally of the threads 6, a somewhat flexible and radially extendable tube 3 is slid over the mounting piece 4. The lumen of the tube 3 is somewhat smaller than the outer diameter of the proximal section of the mouthpiece 2 on which it slid, which keeps the tube 3 firmly attached to the mouthpiece. At the proximal end of the tube, a ring 21 of a rigid material is pressure-mounted on the tube 3. The ring 21 has outer threads that receive the inner threads 22 of a cap 20 by which the proximal end of the tube 3 is closed. The lumen of the tube 3, the mounting piece 4 and the container 7, 8, 14 are filled with ultrasound gel 12. After removal of the cap 20 and insertion of the tube 3 into an ultrasound probe head cover, the gel 12 can be dispensed into the head cover in the vicinity of its closed end. The assembly comprising the container 7, 8, 14, the mounting piece 4 and the tube 3 can be hung up so as to extend vertically with an opening at the proximal end of the tube 3 pointing downwards. Since state-of-the-art ultrasound gel containers do not comprise a means for such vertical disposition, one has to be arranged by the user, for instance by fastening a stirrup 16 at opposite sides of the container 7, 8, 14 at the distal end thereof by means of a suitable adhesive tape 9 (FIG. 1a). A suitable adhesive tape is one that sticks to the polymer of which the container 7, 8, 14 is typically made. By means of the stirrup 16 the assembly comprising the container 7, 8, 14, the mounting piece 4 and the tube 3 can be hung up on a hook (not shown) on the ceiling or on a medical stand.

A second preferred embodiment of the gel dispensing device of the invention is illustrated in FIG. 2. The ultrasound gel container has the form of an oblong soft bag 107. A tube 103, which is integral and in communication with the inner space of the container 107 extends from the proximal end thereof At the proximal end of the tube, a ring 123 provided with outer threads 122 is crimped on the tube 103. The threads 122 are adapted to receive the inner threads 121 of a cap 120 by which the proximal end of the tube 123 is closed when not in use. From the distal end wall of the container 107 extends a flange 108 provided with a central eye 109 by which the gel dispensing device 107, 103 can be fastened to a hook or similar (not shown). The device of FIG. 2 is filled with ultrasound gel 112.

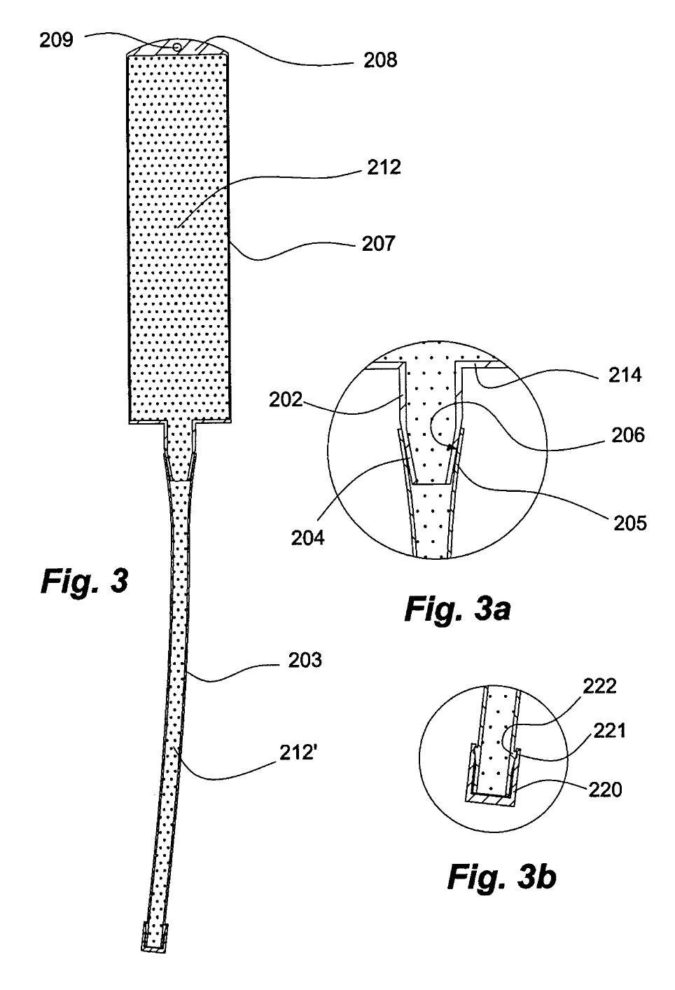

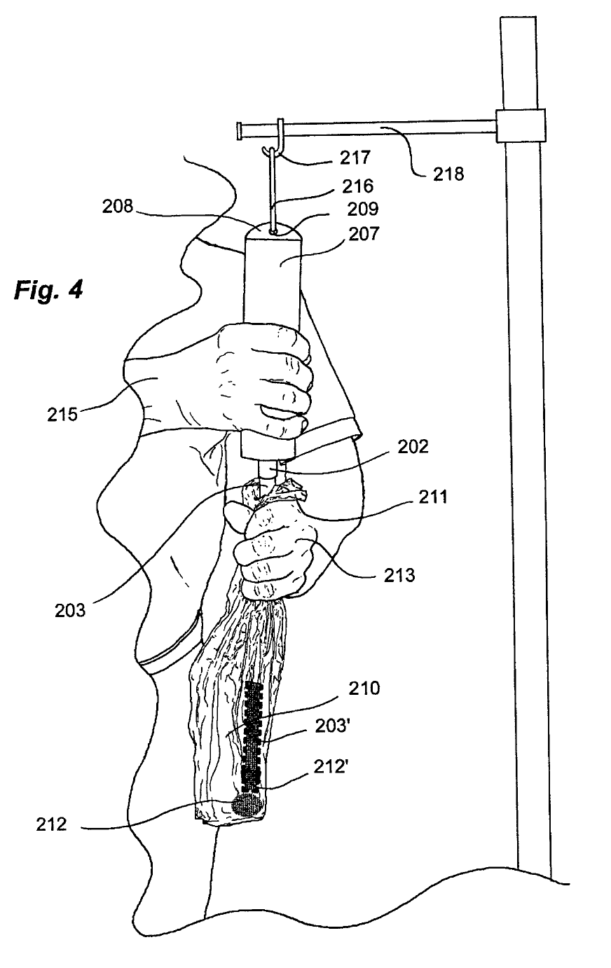

A third preferred embodiment of the gel dispensing device of the invention is illustrated in FIGS. 3, 3a and 3b. The ultrasound gel container has the form of an oblong soft bag 207. The proximal end wall 214 of the bag 207 comprises a central mouthpiece 202, 204. On a tapered portion 204 of the mouthpiece extending from its proximal end is mounted a tube 203. The widened proximal end portion 205 of the tube 203 is held on the tapered portion 204 of the mouthpiece by friction provided, for instance by a roughened contact area 206 of the mouthpiece (FIG. 3a). Near its proximal end the tube 203 comprises a female part 222 of a snap connection. The male part 221 snap connection is disposed in a cap 220, which can be so mounted on the proximal end of the tube 203 as to prevent unwanted release of gel from the device and to prevent the gel disposed in the tube 203 at the front end thereof from drying. From the distal end wall of the bag 207 extends a flange 208 provided with a central eye 209 by which the gel dispensing device 207, 203 can be hung up at a hook or similar (not shown). The device of FIG. 3 is filled with ultrasound gel 212.

The use of the device of FIG. 3 is illustrated in FIG. 4. The device 207, 202, 203 is hung up on a hook 217 of a medical stand 218 by means of a loop of cord 216. The operator holds an ultrasound probe cover 210 by his left hand 213. The operator inserts the tube 203 into the cover 210 so that its proximal portion 203′ with the dispensing opening is disposed near the closed end of the cover 210. By squeezing the ultrasound gel container 207 with his right hand 215 the operator feeds a desired amount of ultrasound gel 212 out of the proximal opening of the tube 203. In FIG. 4 the gel in the proximal end section 203′ of the tube 203 is designated 212′. The device of the invention allows the operator to take full control of the filling procedure. The risk of contaminating the outer face of the ultrasound probe cover with non-sterile ultrasound gel is greatly reduced, as is accidental spillage of gel on the floor, clothing, furniture, etc. It should be noted that the operator usually does wear sterile gloves; although this is not shown in FIG. 4. The use of sterile gloves is indicated if the outside of the cover is to be preserved in a sterile condition. In such case, it may be desirable for the operator to be assisted by a second person in the filling procedure.

The device of the invention is suitably made from a range of polymer materials. However, if desired, the dispensing tube and/and other parts can also be made of metal. The correct choice of suitable materials is within the easy reach of a person skilled in the art, as is the manufacture of the device and parts thereof.

What is claimed is:

1. An ultrasound contact gel dispensing device comprising a flexible container filled with ultrasound contact gel, a dispensing tube having a proximal dispensing end and a distal mounting end, and a mounting device operable for mounting the distal end of the tube on the container.

2. The device of claim 1, wherein the dispensing end of the tube is closable and openable.

3. The device of claim 2, wherein the dispensing tube comprises threads for mounting a threaded lock at the dispensing end of the tube.

4. The device of claim 2, wherein the dispensing tube comprises a snap device for mounting a snap-on lock at the dispensing end of the tube.

5. The device of claim 1, wherein the mounting device of the dispensing tube on the container comprises a threaded connector, a snap-on connector, or a friction connector.

6. The device of claim 1, wherein the dispensing tube is from 15 cm to 50 cm long and has a lumen that, at its most narrow point, is from 12 mm² to 300 mm².

7. The device of claim 1, wherein the mounting device and the dispensing tube and, optionally, the container are integral and of one piece.

8. The device of claim 1, wherein the container includes a closed distal end, having a suspending device for suspending the dispensing device in a vertical orientation.

9. The device of claim 8 wherein the suspending device is an eye, a sling, or a hook.

10. The device of claim 9, wherein the suspending device is sized to provide a suspension height for the dispensing device in which the proximal end of the dispensing tube is disposed at a distance of 80 cm to 150 cm above the floor or ground.

11. The device of claim 1, wherein the means for mounting the tube is in one piece with the tube.

12. The device of claim 1, further comprising a check valve disposed in the tube or at the proximal opening of the container.

13. An ultrasound gel dispensing tube of a length from 15 cm to 50 cm having a dispensing end and a mounting end, the tube mounting end being mountable on a container filled with ultrasound contact gel.

14. The tube of claim 13, comprising one of: a threaded mount, a snap-on mount, and a frictional mount disposed at the mounting end.

15. The tube of claim 13, comprising a releaseable closure at the dispensing end.

16. The tube of claim 15, wherein the releaseable closure is selected from: a threaded closure, a snap-on closure, a frictional closure, or a stopper closure.

17. An ultrasound gel dispensing assembly comprising the dispensing tube of claim 13 and a mounting adapter.

18. The device of claim 1, wherein the dispensing tube is from 15 cm to 50 cm long and has a lumen that, at its most narrow point, is from 30 mm² to 130 mm².

19. The device of claim 1, further comprising an adapter between the proximal opening of the container and the mounting end of the tube.

20. The device of claim 19, further comprising a check valve in the adapter.
